(19) United States
(12) Patent Application Publication
(10) Pub. No.: US 2025/0304083 A1
(43) Pub. Date: Oct. 2, 2025

(54) ENGINE CONTROL METHOD SUITABLE FOR A HYBRID ARCHITECTURE WITH DRIVE BY THE ELECTRIC MOTOR ONLY

(71) Applicant: Schaeffler Technologies AG & Co. KG, Herzogenaurach (DE)

(72) Inventors: Fabien JOSEPH, Toulouse (FR); Thomas MONET, Toulouse (FR)

(21) Appl. No.: 19/063,004

(22) Filed: Feb. 25, 2025

(30) Foreign Application Priority Data
Mar. 27, 2024 (FR) 2403072

(51) Int. Cl. B60W 50/02; B60W 20/50

(52) U.S. Cl. CPC B60W 50/0205; B60W 20/50; B60W 2050/0215; B60W 2510/244

(57) ABSTRACT

A control method implemented in a motor vehicle computer (70), said vehicle comprising both an electric motor (40) and an internal combustion engine (10), the electric motor (40) being powered by at least one battery (30) and configured to drive the wheels (50) of the motor vehicle, and the internal combustion engine (10) being uncoupled from the wheels (50) of the motor vehicle and configured to drive an electric generator (20) that powers said battery (30), the method comprising the following steps:
receiving a synchronization error detection signal (Err), and detecting an operating mode of the internal combustion engine (10);
if it is confirmed that the internal combustion engine (10) is in a reduced operating mode, starting a timer;
when the timer has reached a predetermined time threshold (Thd1), generating a synthetic fault status reset command (C), intended to reset, to a state indicating the absence of a fault, a fault status of each of the at least one associated angular position sensors.

### TECHNICAL FIELD

The invention relates to the field of motor vehicles and more particularly to an engine control method and device suitable for a hybrid architecture with drive by the electric motor only.

### PRIOR ART

So-called hybrid motor vehicles are known in the prior art, that is, motor vehicles provided with an electric motor and a combustion engine that both directly or indirectly contribute to the propulsion of the vehicle.

The invention is more particularly applicable to a hybrid architecture with drive by the electric motor only. In such an architecture, the wheels of the vehicle are driven by the electric motor, which is powered by a battery. The internal combustion engine is uncoupled from the wheels of the vehicle. However, it is configured to drive an electric generator, which powers said battery. The electric motor thus only contributes indirectly to the propulsion of the vehicle and the driving of the wheels, via an action on the charge of the battery powering the electric motor.

In a manner known per se, in an internal combustion engine, one or more cylinders are produced in an engine block and define, with a cylinder head and pistons (one piston for each cylinder), respective combustion chambers. For each combustion performed in the internal combustion engine, the corresponding piston is moved and rotates a crankshaft. In order to control the gas streams entering and leaving each combustion chamber, valves are provided and the opening and closing of these valves are controlled by at least one camshaft. In order to determine the position of the pistons in the internal combustion engine, it is common practice to use a sensor associated with a toothed target rotating with the crankshaft, and a sensor associated with a toothed target rotating with a camshaft. Knowledge of this position is essential for satisfactory operation of the internal combustion engine. The determining of this position is known as “engine synchronization”. Said synchronization is implemented by an engine synchronization unit, defined in a computer that comprises one or more processors and one or more memories. The engine synchronization unit receives as input sensor data from the camshaft sensor (sensor associated with the toothed target rotating with the camshaft) and from the crankshaft sensor (sensor associated with the toothed target rotating with the crankshaft), and provides as output the engine synchronization information. The engine synchronization unit preferably belongs to a computer dedicated to controlling the internal combustion engine. Said computer, known as the engine control computer, comprises one or more processors and one or more memories. It is configured to manage the entire process of controlling the internal combustion engine on the basis in particular of sensor data and external commands reflecting an intention of the user.

The camshaft sensor and the crankshaft sensor both form angular position sensors associated with the internal combustion engine. It may happen that the engine synchronization method does not make it possible to the determine engine position sought, for example because at least one of said angular sensors is defective. In this case, the engine synchronization unit generates an internal combustion engine synchronization error detection signal. Hereinafter, this is simply referred to as an error detection signal. Such a signal may also be generated when the position sought could not be determined successfully within a given time, despite intact angular sensors. This is referred to as false error detection. In any event, said error detection signal indicates a possible fault on at least one angular position sensor associated with the internal combustion engine.

Corresponding to each of the angular position sensors associated with the internal combustion engine is a respective parameter known as fault status, which may adopt at least two values, or states, respectively associated with the absence of a fault and the presence of a (possible or actual) fault on the sensor concerned. Each of said fault statuses is stored in a memory, onboard the motor vehicle in use, for example a memory of the engine control computer.

Upon receipt of the error detection signal, the engine control computer controls an update of at least one of said fault statuses. More particularly, the engine control computer controls a switch from a state associated with the absence of a fault to a state associated with the presence of a fault, of the fault status of at least one of the angular position sensors associated with the internal combustion engine.

The engine control computer then controls a switch of the operating mode of the internal combustion engine, from a normal operating mode to a reduced operating mode.

The reduced operating mode of the engine, or “limp home” mode, denotes a curbed, or limited, or reduced operating mode, in which the maximum rotation speed of the internal combustion engine is limited to a value much lower than normal. The reduced operating mode of the engine is intended, in an architecture provided solely with an internal combustion engine, to allow the user to drive slowly to a nearby repair location.

As explained above, the error detection signal may reflect a false error detection, rather than a genuine failure of an angular position sensor. Provision is therefore made to be able to reset the fault statuses and switch the combustion engine back to its normal operating mode. If it was a false error detection, the engine synchronization will be able to take place without difficulty this time, no error detection signal will be generated, and the internal combustion engine will remain in its normal operating mode. If it was a genuine sensor failure, a sensor failure diagnosis will be confirmed, and the internal combustion engine will be switched to the reduced operating mode again, this time until a maintenance operation has been confirmed.

In a purely conventional architecture, only restarting the internal combustion engine, with a physical key-turn performed by the driver, makes it possible to reset these fault statuses to a state indicating the absence of a fault, thus making it possible to successfully reattempt engine synchronization and return to normal operating mode of the internal combustion engine. The physical action on the key generates a transition in a key signal, which in turn generates an action not only on the starter of the internal combustion engine, but also on the engine control software, with in particular a reset of the fault statuses.

However, in a hybrid architecture as described in the introduction, the combustion engine is generally started not in response to a physical action on the key and a transition in a key signal, but in response to a prompt by a computer configured to control the starting of the combustion engine under certain predetermined conditions such as a high torque request in the drive system of the vehicle or a request to charge the battery. This prompt, or restart request, generates an action on the starter of the internal combustion engine, but not on the engine control software. Said restart request is thus not accompanied by a reset of the fault statuses.

The invention originates from the identification of a flaw in the control of a hybrid drive system as described in the introduction, in which the wheels are driven by the electric motor only.

The aim of the invention is to propose improved control of a hybrid drive system as described in the introduction, in which the wheels are driven by the electric motor only.

### DISCLOSURE OF THE INVENTION

This aim is achieved with a control method implemented in a motor vehicle computer, said vehicle comprising both an electric motor and an internal combustion engine, the electric motor being powered by at least one battery and configured to drive the wheels of the motor vehicle, and the internal combustion engine being uncoupled from the wheels of the motor vehicle and configured to drive an electric generator that powers said battery, the method comprising the following steps implemented when the wheels are driven by the electric motor:
a) receiving a synchronization error detection signal indicating a possible fault on at least one angular position sensor associated with the internal combustion engine;
b) in response to said receipt, detecting an operating mode of the internal combustion engine;
c) if it is confirmed in step b) that the internal combustion engine is in a reduced operating mode, starting a timer;
d1) detecting that the timer has reached a predetermined time threshold; and
e) when at least one predetermined condition is met, including said detection that the timer has reached the predetermined time threshold, generating a synthetic fault status reset command, intended to reset, to a state indicating the absence of a fault, a fault status of each of the at least one associated angular position sensors, said fault status being able to adopt a state indicating the absence of a fault or a state indicating the presence of a fault.

The inventors have observed that, when the internal combustion engine has been switched to the reduced operating mode, this can result in a situation in which:
1/ The internal combustion engine is switched to its reduced operating mode. It then ceases to charge the battery that powers the electric motor, or performs slow charging. The most problematic situation is of course when the internal combustion engine completely ceases to charge the battery. This may happen if a failure is diagnosed, wrongly or rightly, on all of the angular position sensor(s) available for engine synchronization. In this case, all of the angular position sensors associated with the internal combustion engine have their respective fault status(es) switched to a state indicating the presence of a fault. This may occur in a situation in which the vehicle only comprises a single angular sensor for performing engine synchronization. This may also occur in a situation in which a first of the angular sensors is defective, but nevertheless supplies a noisy signal wrongly considered to be a normal signal, so that it is the second of the angular sensors that is wrongly considered to be defective. In this case, when the internal combustion engine is next started (without the resetting of the fault statuses), the second angular sensor is still (wrongly) considered to be defective, and the first angular sensor is this time recognized as defective, so that ultimately all of the angular sensors dedicated to engine synchronization are considered to be defective, leading to the situation in which the internal combustion engine completely ceases to charge the battery.
2/ The electric motor continues to drive the wheels of the vehicle, powered by the battery. The battery will thus discharge gradually, since charging using the combustion engine is prevented or limited.
3/ It may then happen that the electric motor thus continues to drive the wheels of the vehicle until the battery is fully discharged, or until the battery is discharged to below a threshold below which the battery is insufficiently charged to allow the vehicle to be restarted after the motor and engine have been completely switched off.
4/ This then leads to a deadlock situation, in which the internal combustion engine can only leave its reduced operating mode, in the prior art, by means of a restart of the internal combustion engine. However, such a restart is rendered impossible by the excessively low level of charge of the battery. In this situation, the vehicle is rapidly immobilized, since the level of charge of the battery is insufficient to power the electric motor, and the battery cannot be charged as the internal combustion engine is locked in its reduced operating mode.

The invention therefore originates from the identification of the possibility of such a situation.

As described in detail above, the invention is particularly advantageous when a failure is diagnosed, wrongly or rightly, on all of the angular position sensors available for engine synchronization. When engine synchronization uses two angular sensors (camshaft sensor and crankshaft sensor), the probability of such an event is quite low. In certain configurations, however, engine synchronization uses a single angular sensor. In the event of the failure of this single angular sensor, the failure therefore affects all of the angular position sensors available for engine synchronization. The probability of failure of a single sensor is of course very much higher than the probability of simultaneous failure of two independent sensors. It will therefore be understood that the invention is more particularly applicable to this type of configuration, in which engine synchronization uses a single angular sensor.

The invention is also based on the observation that it is the resetting of the fault parameters that actually allows the return to normal operating mode, rather than the request to restart the internal combustion engine.

It is thus proposed, in the invention, to count the time elapsed from the time when the operating mode of the internal combustion engine switches from a normal operating mode to a reduced operating mode. This time count uses the timer mentioned in step c).

As soon as it is detected that this elapsed time has reached a predetermined time threshold, it is proposed to generate a synthetic fault status reset command, intended to reset, to a state indicating the absence of a fault, the fault status of each of the angular position sensors used for engine synchronization. Reference is made to a synthetic fault status reset command, as opposed to a so-called real reset command, generated by the restarting of the internal combustion engine. In the case of a synthetic command, only the fault statuses are affected by the command.

Said predetermined time threshold is calibrated so that the synthetic command is generated quite early, and in any event, before the level of charge of the battery has reached a critical threshold below which a “manual” restart, by actuation of the starter, is no longer possible.

Said synthetic command is configured to control a reset, to a state indicating the absence of a fault, of the fault status of each of the angular position sensors used for engine synchronization. The synthetic command is generated without action on the starter. Throughout the text, the term starter denotes the electric starter of the internal combustion engine.

In a purely conventional architecture (drive using the internal combustion engine only), a physical action on the ignition key of the vehicle generates a transition in a key signal. The term “key off/key on” command can be used to denote this transition of the key signal. The “key off/key on” command generates a command on the starter of the internal combustion engine, known as the internal combustion engine restart request. The internal combustion engine restart request is accompanied by a reset request in the engine control software, in particular with a fault status reset command. In the invention, a so-called synthetic fault status reset command is proposed.

The synthetic command is identical to the fault status reset command that is generated in response to a physical action on the ignition key of the vehicle, in a purely conventional architecture. It will be noted that, in the hybrid architecture according to the invention, the same “key off/key on” command is generated in the event of a physical action on the ignition key of the vehicle, with the same consequences, in particular in terms of resetting the fault statuses. As a result, the synthetic command according to the invention is also identical to the fault status reset command that is generated in response to a physical action on the ignition key of the vehicle, in the hybrid architecture according to the invention. One of the differences is that said synthetic command is not generated as an accompaniment to an action on the starter, but in response to the detection of a certain state of the timer.

The invention thus makes it possible to restart the combustion engine. If the detection of a failure on the angular position sensor(s) was a false detection, the combustion engine will return to its normal operating mode and make it possible to efficiently charge the battery powering the electric motor. The deadlock situation described above is therefore avoided.

In other words, the invention aims to avoid using the battery until it is fully discharged. The invention proposes generating a synthetic signal allowing the internal combustion engine to return to normal operation, after it has switched to reduced operating mode and before the battery level falls below a certain threshold.

Advantageously, the method comprises, in parallel with steps a) to e), at least one iteration of a step of issuing an internal combustion engine restart request, and said request leads to a restart accompanied by a successful synchronization of the internal combustion engine after the resetting of the respective fault statuses by means of the synthetic command. Such a restart request is preferably generated by a computer, or control unit, configured to control the starting of the combustion engine under certain predetermined conditions such as a high torque request in the drive system of the vehicle or a request to charge the battery. This prompt, or restart request, generates an action on the starter of the internal combustion engine, but not on the engine control software. Said restart request is thus not automatically accompanied by a reset of the fault statuses.

Preferably, the synthetic fault status reset command is identical to a real fault status reset command, generated when a user manually actuates a starter of the motor vehicle.

Advantageously, the method further comprises the following step, implemented after step d1):
d2) detecting a current state of charge of the battery powering the electric motor, and comparing it with a predetermined charge threshold.

The at least one predetermined condition of step e) may further include determining that the state of charge of the battery is below the predetermined charge threshold.

Advantageously:
the method comprises, in parallel with steps a) to e), at least one iteration of a step of issuing an internal combustion engine restart request (as described above);
said request leads to a restart accompanied by a successful synchronization of the internal combustion engine after the resetting of the respective fault statuses by means of the synthetic command; and
the method further comprises counting a number of restart requests issued as of step a), the at least one predetermined condition of step e) further including determining that the number of requests is above a predetermined request threshold, and the generation of the synthetic command being implemented regardless of the current state of charge of the battery.

The invention also relates to a computer for a motor vehicle, configured to implement a method according to the invention.

The invention also relates to a motor vehicle comprising both an electric motor and an internal combustion engine, the electric motor being powered by at least one battery and configured to drive the wheels of the motor vehicle, and the internal combustion engine being uncoupled from the wheels of the motor vehicle and configured to drive an electric generator that powers said battery, said vehicle further comprising a computer according to the invention.

### DESCRIPTION OF THE FIGURES

Further features and advantages of the invention will become more apparent upon reading the following description. This description is purely illustrative and should be read with reference to the appended drawings, in which:

FIG. 1 schematically illustrates the system for driving the wheels of a motor vehicle in which the method according to the invention is implemented;

FIG. 2 schematically illustrates a method according to a first embodiment of the invention;

FIG. 3 schematically illustrates a method according to a second embodiment of the invention;

FIG. 4 schematically illustrates a method according to a third embodiment of the invention; and

FIG. 5 schematically illustrates the system for driving the wheels in FIG. 1, together with a computer according to the invention.

### DETAILED DESCRIPTION OF AT LEAST ONE EMBODIMENT

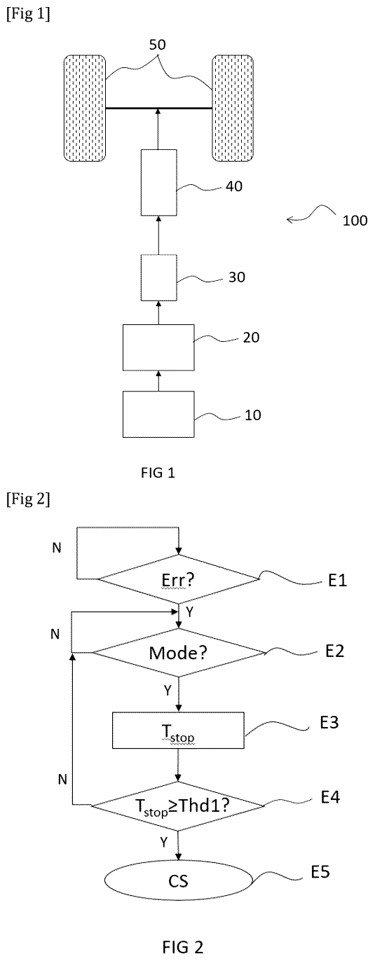

FIG. 1 schematically illustrates the system 100 for driving the wheels 50 of a motor vehicle in which the method according to the invention is implemented.

The system 100 comprises an internal combustion engine 10, which rotates an electric generator 20. The electric generator 20 is configured to convert mechanical energy supplied by the internal combustion engine 10 into electrical energy.

The electric generator 20 is mounted between the internal combustion engine 10 and a battery 30, so that the electrical energy generated charges said battery 30.

Said battery 30 is configured to power an electric motor 40, which rotates an axle comprising a transverse shaft and two drive wheels 50 of the motor vehicle. It will of course be understood that FIG. 1 is a schematic illustration, such that all of the embodiment details are not necessarily illustrated. In particular, no potential mechanical reduction gears between the electric motor 40 and the axle are illustrated.

The internal combustion engine 10 is thus uncoupled from the axle and the wheels 50. Its role is simply to drive the electric generator 20, in order to contribute to charging the battery 30 of the electric motor 40.

A method according to a first embodiment of the invention will now be described with reference to FIG. 2.

The method comprises the following steps, implemented when the wheels 50 are driven by the electric motor 40, itself powered by the battery 30. The method is implemented by a processing unit defined in a computer as described below, which comprises one or more processors together with at least one memory. The computer forms for example an engine control computer as mentioned in the introduction.

### Step E1:

In the first step E1, the processing unit receives a synchronization error detection signal, indicating a possible fault on at least one angular position sensor associated with the internal combustion engine 10. Such an error detection signal is supplied by an engine synchronization unit of said motor vehicle, configured to determine an angular position of a shaft of the internal combustion engine by means of a signal supplied by at least one angular position sensor as described in the introduction (camshaft sensor and/or crankshaft sensor). Said engine synchronization unit is configured to generate an error detection signal when the signals supplied by the at least one angular position sensor do not allow it to determine, within a given time, the angular position sought. Preferably, the engine synchronization unit belongs to the engine control computer as mentioned above. In FIG. 2, this step E1 is represented by the diamond marked with the sign “Err?” symbolizing the interrogation regarding whether or not a synchronization error has been detected.

In a manner known per se, upon receipt of the error detection signal, at least one fault status as described in the introduction is switched from a state indicating the absence of a fault to a state indicating the (possible or actual) presence of a fault. In one advantageous embodiment, the error detection signal in question relates to all of the angular position sensors dedicated to engine synchronization. Such an error detection signal results in a switch in fault status affecting all of said sensors.

In addition, in the method according to the invention, when such an error detection signal is received, step E2 is implemented (see arrow marked with a “Y”). Otherwise, the processing unit continues to await the receipt of such an error detection signal (see arrow marked with an “N”).

### Step E2:

Step E2 consists in detecting a current operating mode of the internal combustion engine 10. In other words, it consists in determining whether, in response to the detection of a synchronization error, the internal combustion engine has been switched (by the control unit of the internal combustion engine 10) from a normal operating mode to a reduced operating mode. Said switch may only be linked indirectly to the detection of a synchronization error, the synchronization error resulting in a switch in the aforementioned fault statuses, which then causes the change in operating mode of the internal combustion engine. In FIG. 2, this step E2 is represented by the diamond marked with the sign “Mode?” symbolizing the interrogation regarding the current operating mode of the internal combustion engine 10.

When it is confirmed in step E2 that the internal combustion engine 10 is in the reduced operating mode, step E3 is implemented (see arrow marked with a “Y”). Otherwise, the processing unit continues to await such confirmation (see arrow marked with an “N”).

### Step E3:

Step E3 consists in starting a timer Tₛₜₒₚ, as soon as it is confirmed that the internal combustion engine 10 is in the reduced operating mode. In FIG. 2, this step E3 is represented by a rectangle marked with the sign “Tₛₜₒₚ”.

### Step E4:

Step E3 is then followed by a step E4 (see arrow marked with a “Y”) of detecting that the timer Tₛₜₒₚ has reached a predetermined time threshold Thd1. In FIG. 2, this step E4 is represented by the diamond marked with the sign “Tₛₜₒₚ≥ Thd1?”, symbolizing the monitoring of the value adopted by the timer and the comparison thereof with the threshold Thd1 in order to identify that said threshold has been reached.

The time threshold Thd1 is advantageously between one minute and sixty minutes, more preferably between one minute and ten minutes, for example five minutes.

As soon as it is detected in step E4 that the timer Tₛₜₒₚ has reached the time threshold Thd1, step E5 is implemented (see arrow marked with a “Y”).

Optionally, the method further comprises detecting a manual internal combustion engine restart command (“key off/key on” command mentioned above). If such a command is detected, the timer Tₛₜₒₚ is reset (see arrow marked with an “N” emerging from block E4). Said manual internal combustion engine restart command is accompanied by a reset of the fault statuses, making it unnecessary to continue to implement the method according to the invention.

### Step E5:

Step E5 consists in generating a synthetic fault status reset command, configured to reset, to a state indicating the absence of a fault, the respective fault status(es) of each of the angular position sensor(s) used for engine synchronization. As explained above, this or these fault status(es) were switched to a state indicating the presence of a fault, upon receipt of the synchronization error detection signal. In FIG. 2, this step E5 is represented by the oval marked with the sign “CS”, symbolizing the issuing of a synthetic command.

As set out in detail below, said synthetic command generation may depend on additional conditions being met. In any event, one condition required for the generation thereof is that the timer Tₛₜₒₚ has reached the time threshold Thd1. In other words, step E5 is implemented when at least one predetermined condition is met, including detecting that the timer Tₛₜₒₚ has reached the predetermined time threshold Thd1.

The synthetic command is sent to a control unit of the internal combustion engine, which may be defined in the same computer as the processing unit implementing the method according to the invention. This synthetic command is similar to a real fault status reset command, generated by a computer of the motor vehicle when a user manually actuates the ignition key of the motor vehicle. The synthetic command generated in the method according to the invention thus makes it possible to deceive the control unit of the internal combustion engine 10. From the point of view of the fault statuses of the angular sensors dedicated to engine synchronization, everything happens as if the engine of the vehicle had been switched off and then restarted, when in reality, the vehicle continues to be driven by virtue of the electric motor 40 the whole time.

As set out in detail in the introduction, the method according to the invention is more particularly applicable in a situation in which:
because of a synchronization error of the internal combustion engine 1, a failure of all of the angular position sensors used for said engine synchronization has been wrongly detected;
in response, the fault statuses of said sensors have been switched to a state indicating the presence of a fault, and the combustion engine 10 has been switched to its reduced operating mode, in which it does not charge, or does not sufficiently charge, the battery 30.

In such a situation, it may happen that, with the vehicle continuing to run over a long period, the battery 30 discharges fully, or at least to below a threshold below which the starter of the combustion engine cannot be activated. In such a situation, the vehicle may then be in a deadlock situation, in which the battery 30 is insufficiently charged to be able to restart the vehicle, and the combustion engine 10 is locked in an operating mode in which it cannot contribute to charging said battery.

The invention makes it possible to avoid reaching this deadlock situation, by ensuring that the combustion engine quickly exits its reduced operating mode when this is possible (that is, when at least one fault detected on the angular sensors is a false detection).

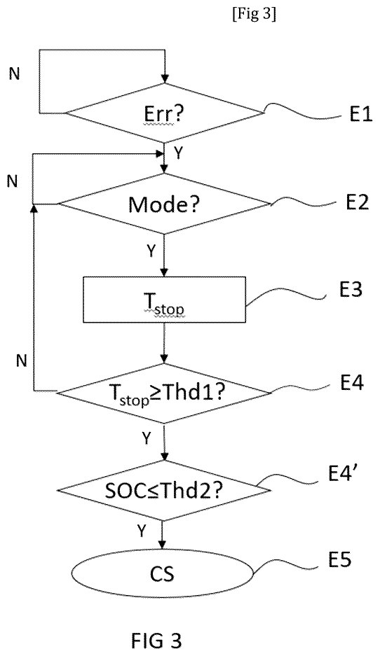

A method according to a second embodiment of the invention will now be described with reference to FIG. 3. The method in FIG. 3 will be described only in terms of its differences in relation to the method in FIG. 2.

In the method in FIG. 3, as soon as it is detected in step E4 that the timer Tₛₜₒₚ has reached the time threshold Thd1, a step E4′ is implemented (see arrow marked with a “Y”).

### Step E4′:

Step E4′ consists in detecting a state of charge of the battery 30, and comparing this state of charge with a predetermined charge threshold Thd2. In FIG. 3, this step E4′ is represented by the diamond marked with the sign “SOC≤Thd2?”, symbolizing the monitoring of the state of charge of the battery and the comparison thereof with the threshold Thd2 in order to identify that said threshold has been reached.

The level of charge is expressed as a percentage, where 100% corresponds to a fully charged state of the battery 30 and 0% corresponds to a fully discharged state of the battery 30.

The time threshold Thd2 is advantageously between 10% and 50%, more preferably between 10% and 20%, for example 15%.

As soon as it is detected in step E4′ that the state of charge of the battery is below the threshold Thd2, step E5 as described above (generating the synthetic command) is implemented (see arrow marked with a “Y”).

The generation of the synthetic command does not thus depend solely on a predetermined period of time elapsing after a switch to the reduced operating mode of the internal combustion engine. The generation of the synthetic command further depends on a current state of charge of the battery 30.

In some cases, the state of charge of the battery 30 is already below the threshold Thd2 when the timer Tₛₜₒₚ reaches the time threshold Thd1. In this case, step E5 is implemented immediately.

In other cases, the state of charge of the battery 30 is above the threshold Thd2 when the timer Tₛₜₒₚ reaches the time threshold Thd1. In this case, step E5 will only be implemented when the state of charge of the battery falls below the threshold Thd2.

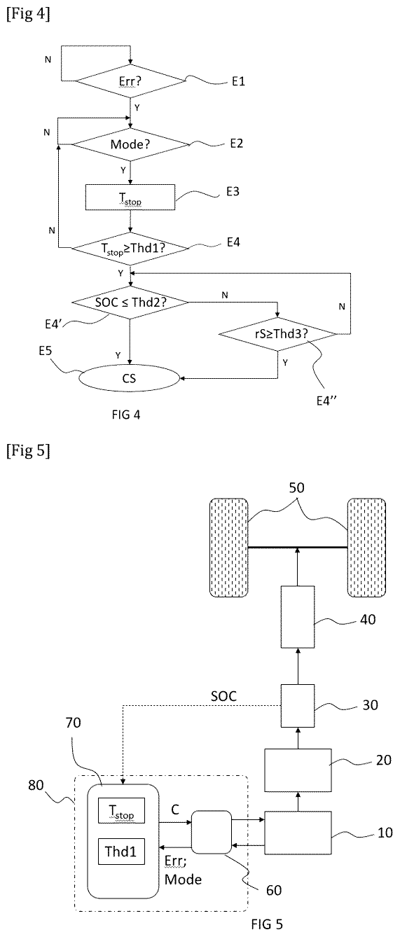

A method according to a third embodiment of the invention will now be described with reference to FIG. 4. The method in FIG. 4 will be described only in terms of its differences in relation to the method in FIG. 3.

In this embodiment, the method according to the invention further comprises at least one iteration of a step of issuing a request to restart the internal combustion engine 10. These restart requests are issued in parallel with the implementation of the steps of the method according to the invention, and starting from the detection of a synchronization error as mentioned with reference to step E1. As set out in detail above, such a restart request is preferably generated by a computer, or control unit, configured to control the starting of the combustion engine under certain predetermined conditions such as a high torque request in the drive system of the vehicle or a request to charge the battery.

Each restart request comprises a command to activate the starter of the internal combustion engine. The engine restart request is accompanied by engine synchronization attempts. If appropriate, there may be several engine synchronization attempts upon a single attempt to restart the internal combustion engine. Each restart request that results in a failed restart attempt is followed by the issuing of a new restart request. As soon as a restart request results in a restart accompanied by a successful synchronization of the internal combustion engine 10, these requests cease to be issued (at least until the next time the engine is switched off or the next failed synchronization). The restart requests are not, by default, accompanied by a reset of the fault statuses.

In order for the restart request to result in a restart accompanied by a successful synchronization, the fault statuses must all be in the state indicating the absence of a fault.

In the embodiment in FIG. 4, an additional step E4″ is proposed.

### Step E4″:

The method in FIG. 4 comprises an additional step E4″ of:
counting a number of restart requests RS issued as of step E1. In other words, a number of failed engine restart attempts from step E1 is counted, and
comparing this with a request threshold Thr3 in order to detect when said number of requests reaches said request threshold Thr3.

In FIG. 4, this step E4″ is represented by the diamond marked with the sign “RS≥Thd3?”, symbolizing the monitoring of the number of requests and the comparison thereof with the threshold Thd3 in order to identify that said threshold has been reached.

The counting of the number of restart requests RS is initiated at the same time as the starting of the timer Tₛₜₒₚ and continues for as long as there is no successful restart of the internal combustion engine. In other words, the count uses a counter that increases on each failed restart and is reset as soon as a restart succeeds. The counting is implemented in parallel with the steps of the method according to the invention.

The comparison with the request threshold Thr3 in order to detect when said number of requests reaches the threshold Thr3 is implemented following step E4′, if it is detected that the state of charge of the battery is above the charge threshold Thd2 (see arrow marked with an “N”).

For the sake of legibility of the figure, step E4″ illustrated in FIG. 4 more specifically corresponds to the comparison with the request threshold Thr3 in order to detect when said number of requests reaches the threshold Thr3.

When it is detected in step E4″ that the number of requests has reached the threshold Thr3, step E5 as described above (generating the synthetic command) is implemented (see arrow marked with a “Y”). As long as this number of requests is below the threshold Thr3, the state of charge of the battery takes priority for the possible generation of a synthetic command C (see arrow marked with an “N”).

Step E5 is thus implemented as soon as a number of failed engine restart attempts has reached a predetermined threshold value Thd3, even if the battery charge level is above the predetermined threshold value Thd2.

The threshold Thd3 is advantageously between 2 and 8, more preferably between 2 and 3, for example equal to 3.

Finally, FIG. 5 schematically illustrates the system for driving the wheels in FIG. 1, together with a processing unit 70 defined in an engine control computer 80, configured to implement a method according to the invention.

The engine control computer 80 comprises at least one processor provided with at least one memory storing instructions which, when they are executed by the at least one processor, implement the method according to the invention. The term processing unit 70 denotes the resources (memory and processor) of the computer 80 that are dedicated to implementing the method according to the invention. The processing unit 70 particularly comprises at least one memory space storing the time threshold Th1, and, where appropriate, the thresholds Th2 and Thd3. The processing unit 70 also incorporates the timer Tₛₜₒₚ as described above. The timer Tₛₜₒₚ is configured to determine a quantity relating to an elapsed time starting from a predetermined time.

The processing unit 70 is configured to receive data from a control unit 60 of the internal combustion engine 10, and to supply the synthetic command C as described above.

The control unit 60 is defined in a computer that comprises at least one processor provided with at least one memory, in this case the engine control computer 70. Said data from the control unit 60 comprises the synchronization error detection signal, denoted “Err”, as well as information relating to the operating mode of the internal combustion engine, denoted “Mode”. Where appropriate, it may further comprise a number of failed engine restart attempts (see embodiment illustrated with reference to FIG. 4).

In some embodiments, the computer 80 comprises at least one input interface, configured to receive state of charge data, denoted SOC, relating to a current state of charge of the battery 30.

Other embodiments and variants of the invention may be implemented without departing from the scope of the invention, for example with different threshold values Thd1, Thd2 and/or Thd3.

1. A control method implemented in a motor vehicle computer (70), said vehicle comprising both an electric motor (40) and an internal combustion engine (10), the electric motor (40) being powered by at least one battery (30) and configured to drive the wheels (50) of the motor vehicle, and the internal combustion engine (10) being uncoupled from the wheels (50) of the motor vehicle and configured to drive an electric generator (20) that powers said battery (30), the method comprising the following steps implemented when the wheels (50) are driven by the electric motor:
a) receiving (E1) a synchronization error detection signal (Err) indicating a possible fault on at least one angular position sensor associated with the internal combustion engine (10);
b) in response to said receipt, detecting (E2) an operating mode of the internal combustion engine (10);
c) if it is confirmed in step b) that the internal combustion engine (10) is in a reduced operating mode, starting (E3) a timer;
d1) detecting (E4) that the timer has reached a predetermined time threshold (Thd1); and
e) when at least one predetermined condition is met, including said detection that the timer has reached the predetermined time threshold (Thd1), generating (E5) a synthetic fault status reset command (C) intended to reset, to a state indicating the absence of a fault, a fault status of each of the at least one associated angular position sensors, said fault status being able to adopt a state indicating the absence of a fault or a state indicating the presence of a fault, the method being characterized in that it comprises, in parallel with steps a) to e), at least one iteration of a step of issuing a request to restart the internal combustion engine (10), and in that said request results in a restart accompanied by a successful synchronization of the internal combustion engine (10) after the resetting of the respective fault statuses by means of the synthetic command (C).

2. The control method as claimed in claim 1, characterized in that the synthetic fault status reset command (C) is identical to a real fault status reset command, generated when a user manually actuates a starter of the motor vehicle.

3. The control method as claimed in claim 1, characterized in that it further comprises the following step, implemented after step d1):
d2) detecting (E4′) a current state of charge (SOC) of the battery (30) powering the electric motor (40), and comparing it with a predetermined charge threshold (Thd2).

4. The control method as claimed in claim 3, characterized in that the at least one predetermined condition of step e) further includes determining that the state of charge of the battery is below the predetermined charge threshold (Thd2).

5. The control method as claimed in claim 4, characterized in that:
the method comprises, in parallel with steps a) to e), at least one iteration of a step of issuing a request to restart the internal combustion engine (10);
said request leads to a restart accompanied by a successful synchronization of the internal combustion engine (10) after the resetting of the respective fault statuses by means of the synthetic command (C); and
the method further comprises counting a number of restart requests issued as of step a), the at least one predetermined condition of step e) further including determining that the number of requests is above a predetermined request threshold (Thd3), and the generation of the synthetic command (C) being implemented regardless of the current state of charge of the battery (30).

6. A computer (70) for a motor vehicle, configured to implement a method as claimed in claim 1.

7. A motor vehicle comprising both an electric motor (40) and an internal combustion engine (10), the electric motor (40) being powered by at least one battery (30) and configured to drive the wheels (50) of the motor vehicle, and the internal combustion engine (10) being uncoupled from the wheels (50) of the motor vehicle and configured to drive an electric generator (20) that powers said battery (30), said vehicle further comprising a computer (70) as claimed in claim 6.
